(19) United States
(12) Patent Application Publication
(10) Pub. No.: US 2002/0024412 A1
(43) Pub. Date: Feb. 28, 2002

(54) Method of manufacturing a relay

(75) Inventor: Sung-Jen Wu, Taipei Hsien (TW)

Correspondence Address: BACON & THOMAS, PLLC, 625 SLATERS LANE, FOURTH FLOOR, ALEXANDRIA, VA, 22314

(73) Assignee: Song Chuan Precision Co., Ltd.

(21) Appl. No.: 09/885,123

(22) Filed: Jun. 21, 2001

Related U.S. Application Data
(62) Division of application No. 09/644,206, filed on Aug. 23, 2000.

(51) Int. Cl. H01H 67/02

(52) U.S. Cl. 335/129

(57) ABSTRACT

A relay includes a base, at least on set of contact mechanism, a container on the rear side of the base, an electromagnetic mechanism arranged inside the container, a slide piece disposed between the moveable contactor of the contact mechanism and the moveable plate of the electromagnetic mechanism as well as above the electromagnetic mechanism. And a housing covers all components mentioned above. The improvement of the present invention is characterized in that there is a distance from the electromagnetic mechanism to the inner wall of the container after it is disposed into the container. A driver pushes a moveable plate forwardly so that the electromagnetic mechanism can move the moveable contactor through the slide card for contacting the front fixed contactor properly. Afterwards, the frame of electromagnetic mechanism is also pushed by the driver and moved on with a preset distance. Then put glue to attach the electromagnetic mechanism onto the base.

### BACKGROUND OF THE INVENTION

The present invention relates to a relay and its manufacturing method, especially to a relay that the contact force between the moveable contactor of the contact mechanism and the front fixed contactor is set and adjusted conveniently and precisely so that the yield rate and the quality of relay products can be improved.

The conventional relay is composed of a base 1, a contact mechanism 2, an electromagnetic mechanism 3, a slide piece 4 and a housing 5 (as shown in FIGS. 1 to 3). A plurality of pin holes 11 are disposed at the front side of the base 1 for mounting at least one set of contact mechanism 2. In the embodiment of the present invention, a single contact mechanism is used for demonstration. A rectangular container 12 is arranged at the rear side of the base.

Each set of the contact mechanism 2 includes a moveable contactor 22, a front fixed contactor 21 and a rear fixed contactor 23, which is inserted into the terminal hole 11 on the base 1 respectively and the terminal legs exposed outside the bottom of the base 1. The topside of the moveable contactor 22 is inclined rearward so as to contact with the rear fixed contactor 23 and forms an always-on contact point. And an always-off contact point forms between the moveable contactor 22 and the front fixed contactor 21.

The electromagnetic mechanism 3 is accommodated in the container 12 on the rear side of the base 1. It includes a plastic frame 31 with coils 32 around and a magnetic pole 33 inside thereof. A moveable plate 34 is disposed on the rear bottom of the plastic stand 31 and swings due to the magnetism of the pole 33 that forms when a current is passes through the coil.

The slide card 4 is made of insulating material and is attached to the top of the electromagnetic mechanism 3 on the base 1. The slide card 4 is mounted between the moveable contactor 22 of the contact mechanism 2 and the moveable plate 34 of the electromagnetic mechanism 3.

A housing 5 is made of plastic material. After being assembled with the base 1, the above-mentioned other components are covered inside and forms a whole device.

However, the conventional structure of relay as mentioned above, as to the always-off contact point, a moveable contactor 22 is against the rear fixed contactor 23 naturally by spring thereof. And there is a space for the movement of the slide card 4 and the moveable plate 34. Thus it's easy to assemble. On the other hand, as to the always-on contact point, the length of the rectangular container 12 is the same with that of the electromagnetic mechanism 3 so that it is difficult to make an adjustment after the electromagnetic mechanism 3 being accommodated into the rectangular container 12 on the base 1. At the same time, the electromagnetic mechanism 3 is attached firmly as being mounted into the container 12. Every detail and dimension of each components should be produced quite precisely otherwise it's easy to make bad contact on the always-on contact point (between the moveable contactor 22 and the front fixed contactor 21) due to the shortage of spring movement of the moveable contactor 22 when the electromagnetic mechanism 3 moves. Thus the quality and manufacturing cost will be increased.

It's not easy to make every part without tolerance during the manufacturing process, especially for the front fixed contactor 21, the moveable contactor 22 and the rear fixed contactor 23 that made of copper. Due to the thinness of the copper pieces and without any support material, the three components above-mentioned are easy to be deformed when being inserted into the terminal hole 11 respectively on the base 1. For the better contact of the always-off contact point, the moveable contactor 22 is bent back more? so as to be towards the rear fixed contactor 23 preferably. Thus if the electromagnetic mechanism 3 and the insulating member 4 are fixed on the base 1 too early, the reaction between the insulating member 4 and the moveable contactor 22 will be too weak to make the moveable contactor 22 and the front fixed contactor 21 contact well. Therefore, the relay is easy to contact poor or have flashover, or even out of order. (broke down)

### SUMMARY OF THE INVENTION

Therefore, the primary object of the present invention is to provide a relay and the related manufacturing method in which the always-on contact point and the always-off contact point can have better contact so that the relay can have longer lifetime.

A further object of the present invention is to provide a relay in which the contact force between the front fixed contactor 21 and the moveable contactor 22 is proper and precisely controlled so that the number of rejected products can be reduced and the manufacturing cost is also down.

In order to achieve the objects mentioned above, the container on the rear side of the base is elongated 0.5-3 mm longer than the length of the electromagnetic mechanism. When being assembled, the electromagnetic mechanism is secured into the container on the base and there is a certain distance between the front end of the electromagnetic mechanism and the inner wall of the container. Before fixing the electromagnetic mechanism, a slide piece is fitted between a moveable contactor and a moveable plate. A driver for certain distance arranged on the rear side of the moveable plate pushes a moveable plate forwardly to move the moveable contactor for contacting the front fixed contactor properly. Further, the frame of electromagnetic mechanism is also pushed by the driver and moved on with a preset distance. Afterwards, put a dab of glue to attach the electromagnetic mechanism to the base. Thus the contact force between the moveable contactor of the contact mechanism and the front fixed contactor is set conveniently and precisely through the pushing of the slide card. Then the driver for certain distance is removed and cover the all above components with a housing.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an explosive view of a relay;

FIG. 2 is an assembling view of the relay in FIG. 1;

FIG. 3 is a cross-sectional view of a conventional relay;

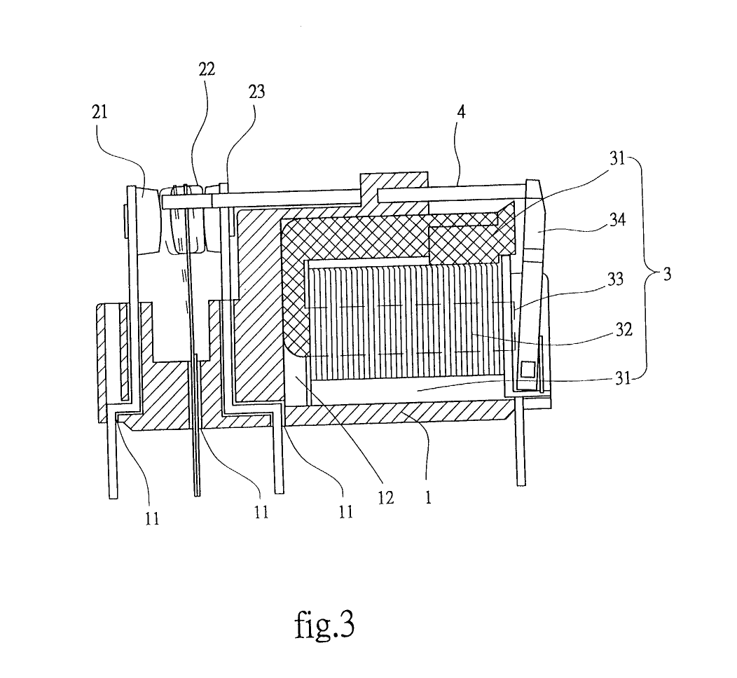

FIG. 4 is a cross-sectional view of a relay in accordance with the present invention.

### DETAILED DESCRIPTION OF THE PREFERRED EMBODIMENT

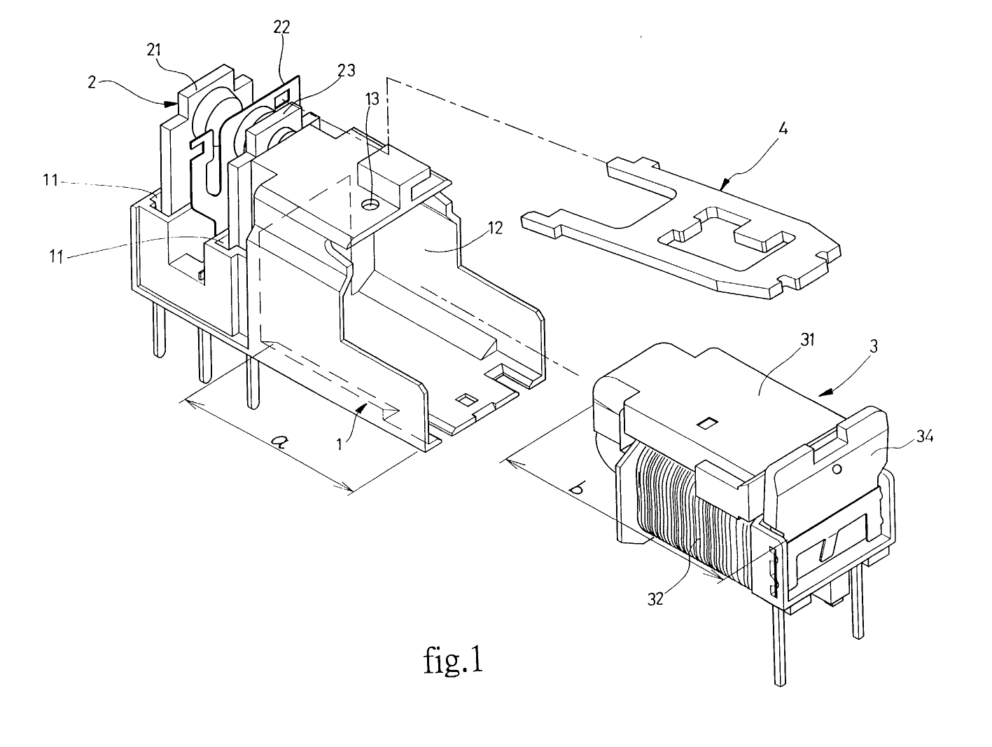

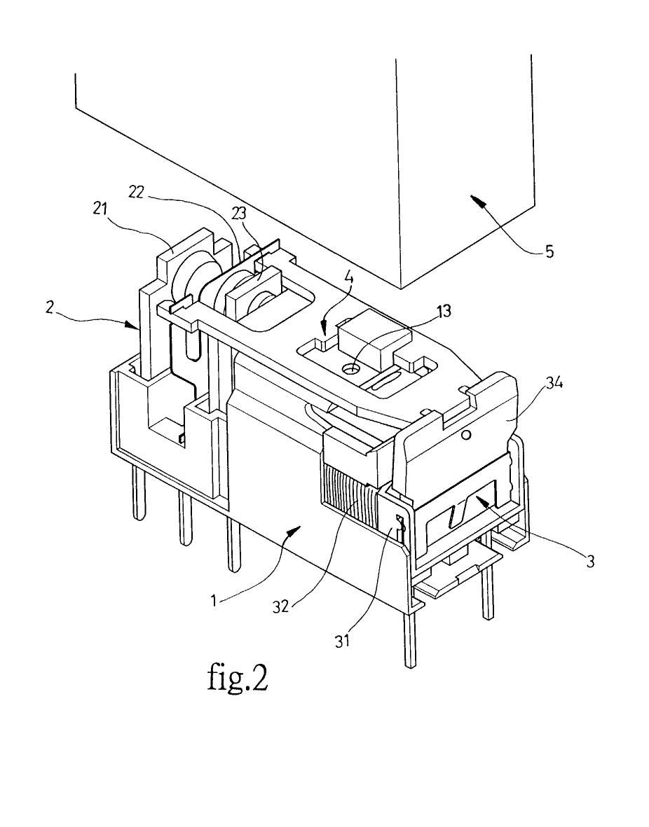

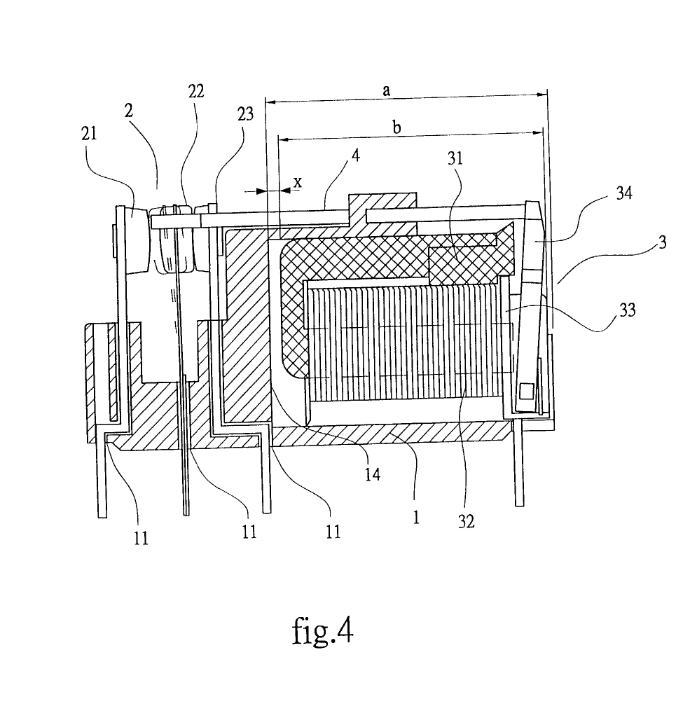

Referring to FIG. 1. FIG. 2 and FIG. 4, a relay in accordance with the present invention primarily includes a base 1, at least on set of contact mechanism 2 arranged on the front side of the base 1, a container 12 mounted on the rear side of the base 1, an electromagnetic mechanism 3 arranged inside the container 12, a slide piece 4 disposed between the moveable contactor 22 of the contact mechanism 2 and the moveable plate 34 of the electromagnetic mechanism 3 as well as above the electromagnetic mechanism 3. And at last a housing 5 covers all components mentioned above. The improvement of the present invention is characterized in: the length of the container 12 on the rear side of the base 1 (a) is 0.5-3 mm longer than that (b) of the electromagnetic mechanism 3.

As the foregoing structure, the manufacturing and assembling process includes the following steps: Placing the electromagnetic mechanism 3 into the container 12 on the base 1 and keep the certain distance X (at least 0.5-1.5 mm) between the front end of the electromagnetic mechanism 3 and the inner wall 14 of the container 12. Before the electromagnetic mechanism 3 is attached firmly into the container 12, a slide piece 4 is inserted between a moveable contactor 22 and a moveable plate 34. Then a driver (a kind of stepping motor including pneumatic pump, motor, or man-power type, not shown in FIG.) for certain distance pushes the moveable plate 34 from behind so that the electromagnetic mechanism 3 moves forwardly. And through the movement of the moveable plate 34 and the slide card 4, the moveable contactor 22 is pushed towards the front fixed contactor 21. The action of the driver stops when the moveable contactor 22 just contacts the front fixed contactor 21. Afterwards, the driver is used to push the frame 31 of the electromagnetic mechanism 3 in order to move for a preset distance. Then put a dab of glue into a hole 13 on the top of the base 1 to attach the electromagnetic mechanism 3 onto the base 1.

The space of the container 12 on the base 1 is larger than the conventional relays and the frame 31 of the electromagnetic mechanism 3 is fixed by instant glue after being moved by the driver for a proper distance (about 0.05-0.5 mm ) so that when the moveable plate 34 is attracted by the magnetic pole 33, the moveable contactor 22 can not only contact the front fixed contactor 21 but also push forwardly to make a proper contact force. Therefore, the electric performance of the circuit is improved and the spark or short circuit due to the bad contact can be prevented. The lifetime and quality of the present invention are also improved thus increase its value.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A relay primarily comprising a base, at least one set of contact mechanism arranged on the front side of said base, a container mounted on the rear side of said base, an electromagnetic mechanism arranged inside said container, a slide piece disposed between a moveable contactor of said contact mechanism and a moveable plate of said electromagnetic mechanism on the topside of said electromagnetic mechanism, a housing covering all components mentioned above; the improvement of said relay is characterized in

2. A relay and the method of manufacturing relays, wherein said relay includes a base, at least one set of contact mechanism arranged on the front side of said base, a container mounted on the rear side of said base, an electromagnetic mechanism arranged inside said container, a slide piece disposed between a moveable contactor of said contact mechanism and a moveable plate of said electromagnetic mechanism on the topside of said electromagnetic mechanism; the length of said container is 0.5-3 mm longer than the length of said electromagnetic mechanism so that there is a distance from said electromagnetic mechanism to the inner wall of said container after said electromagnetic mechanism is disposed into said container, then a driver pushes said moveable plate forwardly so that said electromagnetic mechanism moves said moveable contactor through said slide card for contacting a front fixed contactor properly and a frame of said electromagnetic mechanism is also pushed by said driver and moved on with a preset distance, then put glue to attach said electromagnetic mechanism onto said base for fixing thereon.
